(19) United States
(12) Patent Application Publication
(10) Pub. No.: US 2007/0077922 A1
(43) Pub. Date: Apr. 5, 2007

(54) Method and system for providing message broadcast service using open application program interface

(75) Inventors: Jeong Hwan Kim, Daejeon (KR); Sang Ki Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics & Telecommunications Research Institute

(21) Appl. No.: 11/323,900

(22) Filed: Dec. 30, 2005

(30) Foreign Application Priority Data
Oct. 4, 2005 (KR) 10-2005-93165

(51) Int. Cl. H04Q 7/22

(52) U.S. Cl. 455/414.2

(57) ABSTRACT

A system and method for providing a message broadcast service using an open API is provided, which allows a third party information provider to easily broadcast messages to the general public in a specific service area using a Cell Broadcast Service (CBS) of a mobile communication system. A message broadcast application server provides a user interface for composing a broadcast message and defining a service area to a third party information provider. When a broadcast message transmission request is received from the third party information provider through the user interface, a broadcast message transmission request command, a broadcast message transmission request cancellation command, or a status query message is created according to the message broadcast service request, and is then processed by a Cell Broadcast Center (CBC) in the mobile communication system through an open API of a Parlay gateway.

### RELATED APPLICATION

The present application is based on, and claims priority from, Korean Application Number 10-2005-0093165, filed Oct. 4, 2005, the disclosure of which is incorporated by reference herein in its entirety.

### BACKGROUND OF THE INVENTION

1. Field of the Invention

The present invention relates to a system and method for providing a message broadcast service using an open Application Program Interface (API) whereby a third party information provider can easily broadcast desired information to a plurality of mobile communication terminals present in a specific service area using a Cell Broadcast Service (CBS) of a mobile communication system.

2. Description of the Related Art

The Cell Broadcast Service (CBS), which is a communication network capability provided through a mobile communication system, is a service for transmitting short messages or multimedia messages simultaneously to a number of mobile communication terminals through a base station of the mobile communication system. The CBS has a lower rate of information arrival to each individual than a Short Message Service (SMS) or a Multimedia Message Service (MMS). However, the CBS has a low switching load to a mobile communication system, low paging channel traffic, and low transmission costs. Also, the CBS can transmit multimedia information such as Video On Demand (VOD) data and provide a Location Based Service (LBS), thereby allowing mobile advertisement/marketing based on service areas.

Examples of information that can be provided using the CBS include weather, traffic situation, and disaster/hazard warning information, and also include information of a specific service that is mainly provided in a specific area due to the characteristics of the service or information in which the general public is commonly interested.

Such information is broadcast to a number of mobile communication terminals through a Cell Broadcast Center (CBC) provided in the mobile communication system. Mobile communication users can receive desired information by setting whether to receive the information and registering channels of interest in their mobile communication terminals.

Since mobile communication providers individually manage entities which provide content and information to be broadcast in the conventional Cell Broadcast Service, it is difficult for a third party information provider, such as a third party service provider or an entity aimed at providing public information, to use the CBS capabilities of the mobile communication system when providing information to mobile communication users through the cell broadcast service.

For example, when institutions or entities need to protect national loss such as loss of life and property by providing warning information to areas, in which a typhoon, flood, or earthquake is to occur, through the cell broadcast service, the institutions or entities must individually negotiate with mobile communication providers and establish and operate systems for providing the service to be compatible with interfaces required by the mobile communication systems of the mobile communication providers. This is very inefficient in terms of resources and costs.

Recently, the Parlay group has suggested an open Application Program Interface (API) technology, which provides a standardized interface between an application service layer and a communication network transport layer and defines an abstracted API that can be used for wired/wireless communication network capabilities such as a wired/wireless call control capability, a capability to transmit and receive SMS and MMS messages, and a capability to provide location information of specific subscribers. The open API technology has been released in the 3GPP, ETSI, and 3GPP2 specifications through Joint Working Group (JWG) activities with the members of the 3GPP, which is a de-facto standardization organization for third generation mobile communication.

The open API provides environments allowing a third party to easily develop and manage services without depending on a specific communication network. Communication network capabilities, which can be currently used through the open API, include a wired/wireless call control and additional call processing capability, an SMS/MMS transmission/reception capability, a location information provision capability, a charging & account management capability, and a Presence and Availability Management (PAM) capability.

However, if a third party service provider or entity other than the mobile communication providers can provide the cell broadcast service through such an open API architecture, it will be easy to access the CBS capabilities through a unified interface and to create and provide a variety of services employing the CBS capabilities.

Thus, there is a need to define an open API for the communication network capabilities (i.e., the CBS capabilities) and provide a method for processing and providing the service through such a defined open API.

### SUMMARY OF THE INVENTION

Therefore, the present invention has been made in view of the above problems, and it is an object of the present invention to provide a system and method for providing a message broadcast service using an open API whereby an entity external to a mobile communication system can use Cell Broadcast Service (CBS) capabilities based on the open API technology.

It is another object of the present invention to provide a system and method for providing a message broadcast service using an open API whereby a third party information provider can easily access CBS capabilities without depending on a specific mobile communication system and broadcast messages in text format to a plurality of unspecified mobile communication terminals present in a specific service area.

In accordance with one aspect of the present invention, the above and other objects can be accomplished by the provision of a method in which a message broadcast application server provides a message broadcast service using an open Application Program Interface (API), wherein a broadcast message is transmitted to a plurality of mobile communication terminals using Cell Broadcast Service (CBS) capabilities of a mobile communication system through the open API, the method comprising providing a user interface for composing a broadcast message and defining a service area to a third party information provider; receiving a broadcast message transmission request from the third party information provider through the user interface; creating a broadcast message transmission request command using the broadcast message composed and the service area defined through the user interface upon receiving the broadcast message transmission request from the third party information provider; and transferring the broadcast message transmission request command to the mobile communication system through the open API.

In accordance with another aspect of the present invention, there is provided a message broadcast service system for providing a message broadcast service using an open Application Program Interface (API), the system allowing a third party information provider to broadcast a specific message to a mobile communication terminal through CBS capabilities of a mobile communication system, the message broadcast service system comprising a message broadcast application server for providing a user interface so that the third party information provider can compose a broadcast message and define a service area where the broadcast service is to be transmitted and for invoking an open API for message broadcasting based on information of the service area and the broadcast message of the third party information provider received through the user interface; and a Parlay gateway for converting a message broadcast service-related request of the message broadcast application server so as to comply with a protocol of the CBC of the mobile communication system and transferring the converted request to the CBC through protocol interworking with lower network resources of the mobile communication system, and inverse-converting and transferring a message received from the CBC to the message broadcast application server.

In accordance with still another aspect of the present invention, there is provided a message broadcast application server comprising a user interface processing unit for providing a user interface that supports an information provider to define a service area and compose a broadcast message and for receiving a message broadcast service-related request from the information provider or providing message broadcast service-related information to the information provider through the user interface; a database in which the user interface processing unit stores map data required to define a service area; and a message broadcast processing logic for creating a command for processing the broadcast message according to a request of the information provider received through the user interface processing unit, invoking an open API, and receiving a response to the command, whereby the message broadcast application server can transmit a broadcast message to mobile communication terminals present in a specific service area using CBS capabilities of the mobile communication system through the open API.

In accordance with yet another aspect of the present invention, there is provided a Parlay gateway comprising a CBS Service Capability Feature (SCF) comprising a message broadcast web service request processing block for implementing and distributing an open API for broadcast message services in Web Services Description Language (WSDL) and processing a request for a message broadcast service accessed and invoked through the open API; a message conversion and management block for converting a web service request made by the message broadcast web service request processing block so as to comply with a protocol of a mobile communication system, inverse-converting a processing result of the web service request received from the mobile communication system, converting an ID of the API invocation into a lower protocol session ID, and managing the lower protocol session ID; a session management DB for storing session information processed by the message conversion and management block; and a CBC-interworking processing block for transmitting a request, which has been converted to a lower protocol message by the message conversion and management block, to a Cell Broadcast Center (CBC) of the mobile communication system, receiving a response to the request from the CBC, and transferring the received response to the message conversion and management block, whereby the Parlay gateway allows a message broadcast application server to transmit a broadcast message to mobile communication terminals present in a specific service area using CBS capabilities of the mobile communication system through the open API.

### BRIEF DESCRIPTION OF THE DRAWINGS

The above and other objects, features and other advantages of the present invention will be more clearly understood from the following detailed description taken in conjunction with the accompanying drawings, in which:

FIG. 1 illustrates the structure of a message broadcast service network according to the present invention;

FIG. 2 is a detailed block diagram of a message broadcast application server in a system for providing message broadcast services according to the present invention;

FIG. 3 is a detailed block diagram of a Parlay gateway in the system for providing message broadcast services according to the present invention; and

FIG. 4 is a signal flow diagram of a method for providing message broadcast services according to the present invention.

### DESCRIPTION OF THE PREFERRED EMBODIMENTS

A system and method for providing a message broadcast service according to the present invention will now be described with reference to the accompanying drawings.

The present invention provides an open API for message broadcast services associated with CBS capabilities provided by a mobile communication system and also provides a method and apparatus for providing a message broadcast service through the open API. The present invention can be commonly applied to 2G or 3G mobile communication networks which provide CBS capabilities and any future mobile communication network which provides CBS capabilities.

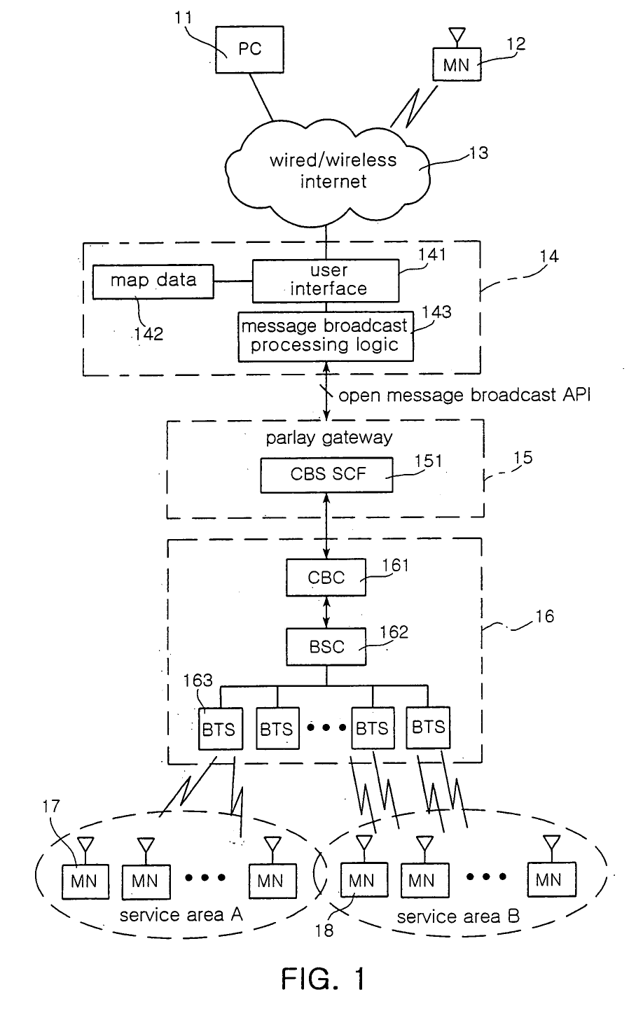

FIG. 1 illustrates the structure of a message broadcast service network according to the present invention.

As shown in FIG. 1, the message broadcast service network comprises information provider terminals 11 and 12, the wired/wireless Internet 13, a message broadcast application server 14, a Parlay gateway 15, a mobile communication system 16, and a plurality of mobile communication terminals 17 and 18.

The information provider terminals 11 and 12 are terminals which information providers use in order to request message broadcasting. The information providers are providers of message broadcast service information. The information providers are, for example, third party service providers, unrelated to mobile communication providers, or public-purpose institutions or entities. The information provider terminals 11 and 12 may include personal computers (PCs) such as notebooks or desktops connected to the wired Internet and mobile communication terminals connectable to the wireless Internet.

The wired/wireless Internet 13 connects the information provider terminals 11 and 12, which have a feature to access the wired or wireless Internet, to the message broadcast application server 14 that performs a message broadcast service according to the present invention.

The message broadcast application server 14, which is implemented outside the mobile communication system 16, combines resources in the Internet area with capabilities (particularly, CBS capabilities) in the communication network area and processes message broadcast services using the CBS capabilities of the mobile communication system 16. The message broadcast application server 14 has a user interface function and a service processing function for providing message broadcast services. The message broadcast application server 14, which provides application services requiring the CBS capabilities, can be applied to, for example, a server for providing disaster information of the Disaster Prevention Office, etc., or a server for providing advertisement or marketing information to consumers in specific areas for commercial purposes.

The message broadcast application server 14 comprises a user interface processing unit 141, a database 142, and a message broadcast processing logic 143, which will be described in detail later.

The Parlay gateway 15 is an open service gateway which supports an open API of the CBS capabilities of the mobile communication system 61 and processes a request made as the CBS API is invoked through protocol interworking with lower network resources. To implement this process, the Parlay gateway 15 includes a CBS Service Capability Feature (SCF) 151.

In addition, the Parlay gateway 15 provides an open API of other service features (or capabilities) provided by the mobile communication system 16 and includes respective SCFs of the service features. For example, the Parlay gateway 15 has conventional capabilities such as a short messaging capability (Short Message Service (SMS) SCF) for processing or transferring SMS messages to the mobile communication network, a multimedia messaging capability (Multimedia Message Service (MMS) SCF) for processing or transferring MMS messages to the mobile communication network, a call control capability (Third Party Call (TPC) SCF) for performing a phone call control function, and a presence capability (Presence SCF) for processing status information of specific users. These capabilities are not directly related to message broadcast services according to the present invention and are only example components of the Parlay gateway 15. In the present invention, the Parlay gateway 15 needs to include a CBS SCF 151 for receiving and transferring message broadcast API calls (or invocations) to the communication network in order to provide message broadcast services.

The mobile communication system 16 provides services including voice and data communication services to a number of mobile communication terminals 17 and 18 and comprises Base Transceiver Stations (BTSs) 163 for wireless communication with the mobile communication terminals 17 and 18, a Base Station Controller (BSC) 162 for controlling the BTSs, a Mobile Switching Center (MSC), connected to one or more BSCs, for exchanging calls for voice communication, an Interworking Function (IWF) for performing conversion between voice and packet data formats, a Short Message Service Center (SMSC), connected to the MSC, for transmitting and receiving SMS messages, a Packet Data Service Node (PDSN) for interworking with the wired/wireless Internet to provide packet data services to the mobile communication terminals 17 and 18, and a Cell Broadcast Center (CBC) 161 for providing a cell broadcast service to transfer data simultaneously to a plurality of mobile communication terminals 17 and 18.

Only some (i.e., the CBC 161, the BSC 162, and the BTSs 163) of the components of the mobile communication system 16, which are directly related to the provision of message broadcast services according to the present invention, are illustrated in FIG. 1. The CBC 161 is responsible for actually processing CBS requests inside the mobile communication network. Specifically, the CBC 161 analyzes a cell broadcasting request received through the Parlay gateway 15 using a cell ID of the mobile communication network and transmits a broadcast message to a BSC 162 and a BTS 163 corresponding to the cell ID. The BSC 162 and the BTS 163 then transmits the broadcast message received from the CBC 161 to mobile communication terminals 17 and 18 present in an area defined by an information provider.

The mobile communication terminals 17 and 18 are terminals of mobile communication subscribers of the mobile communication system 16 and have functions to receive and display messages in addition to wireless communication and voice processing functions. Mobile communication terminals 17 present in a service area A and mobile communication terminals 17 present in a service area B are separately illustrated in FIG. 1. The service areas A and B are managed by the corresponding BTSs 163. The service areas A and B are defined in units of cells and are selected by the information provider. Specifically, when two different third party information providers make a broadcast message transmission request after defining service areas A and B, respectively, they can transmit different broadcast messages to the service areas A and B.

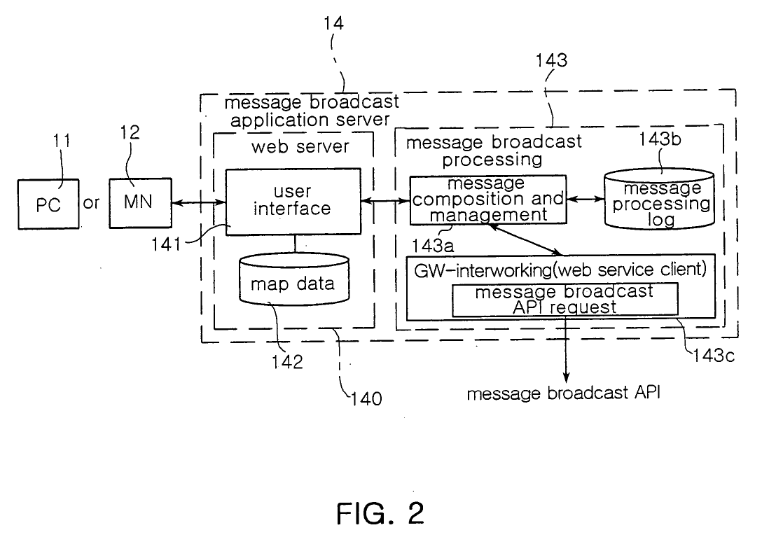

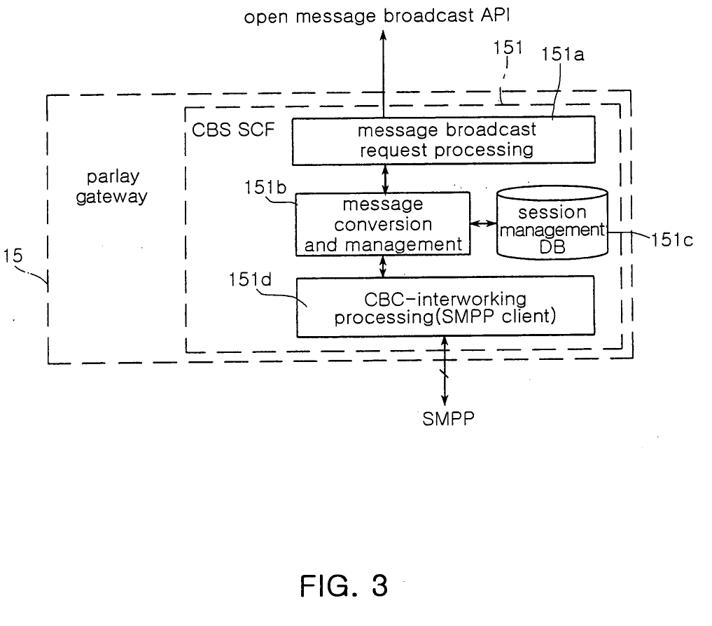

FIGS. 2 and 3 are detailed functional block diagrams of the message broadcast application server 14 and the Parlay gateway 15 according to the present invention.

As shown in FIG. 2, the message broadcast application server 14 mainly comprises a web server 140 and a message broadcast processing logic 143. The web server 140 provides a user interface for a message broadcast service through the wired/wireless Internet 13 and receives a message broadcast service-related request through the user interface. The message broadcast processing logic 143 invokes an open API for a cell broadcast service according to a message broadcast service-related request received from the web server 140.

The web server 140 comprises a user interface processing unit 141 and a database 142. The user interface processing unit 141 provides a web GUI that supports an information provider to request that a service area be set and a broadcast message be transmitted to the service area, and receives a message broadcast service-related request from the information provider through the web GUI. The database 142 stores map data representing an area where a message broadcast service is to be provided. The message broadcast processing logic 143 comprises a message composition and management block 143a, a storage unit 143b, a gateway-interworking block 143c. The message composition and management block 143a composes and manages a broadcast message in a format set according to an information provider request input through the user interface processing unit 141. The storage unit 143b stores log information of the broadcast message composed and transmitted by the message composition and management block 143a. The gateway interworking block 143c interworks with the Parlay gateway 15 to invoke an open API and transmits a request to broadcast the message composed by the message composition and management block 143a and a query about message transmission states.

As shown in FIG. 3, the CBS SCF 151 in the Parlay gateway 15 comprises a message broadcast web service request processing block 151a, a message conversion and management block 151b, a session management DB 151c, and a CBC-interworking processing block 151d. The message broadcast web service request processing block 151a functions to receive a message broadcast-related request from the gateway interworking block 143c in the message broadcast application server 14 and convert the received message into a format, which can be processed by the mobile communication system 16, and then to transmit the converted request to the CBC 161 in the mobile communication system 16. The message broadcast web service request processing block 151a is also responsible for implementing and distributing a message broadcast API in Web Services Description Language (WSDL) and processing a message broadcast web service accessed and invoked through the message broadcast API. The message conversion and management block 151b performs message conversion to convert a web service invocation request made by the message broadcast web service request processing block 151a into a message for transmission to the CBC 161 and performs inverse message conversion to convert a processing result received from the CBC 161 back to a web service message. The message conversion and management block 151b converts an ID of the web service invocation (or request) to an ID of a Short Message Peer-to-Peer (SMPP) session, which is a protocol for accessing the CBC 161, and manages the SMPP session ID. The session management DB 151c stores the session information. The CBC-interworking processing block 151d transmits a request, which has been converted to a message of a lower protocol such as the SMPP through the message conversion and management block 151b, using an SMPP protocol command, and receives and returns a response to the request to the message conversion and management block 151b.

The overall flow of a method for providing a message service according to the present invention will now be described with reference to the message broadcast service network structure described above.

When an information provider desires to provide information to mobile communication users in a specific area using CBS communication network capabilities, the information provider accesses the message broadcast application server 14 using the terminals 11 and 12 through the wired/wireless Internet 13.

The user interface processing unit 141 of the message broadcast application server 14 provides a web GUI for requesting a message broadcast service from the information provider and defining a service area, and processes information input through the web GUI. Map data stored in the database 142 is used to provide the web GUI.

The information provider can compose a desired message to be broadcast through a user interface provided by the message broadcast application server 14 and can define a service area where the message is to be broadcast through the GUI interface provided by the user interface processing unit 141. For example, when a web screen regarding a map stored in the database 142 is provided through the user interface processing unit 141, the information provider can define a desired service area by specifying a corresponding area using a mouse, etc., on the web screen. Geographical information for defining the service area can be represented using an ellipsoid arc representation method or a polygon representation method specified in Geographical Area Description (GAD) specifications (3GPP TS 23.032).

The message broadcast processing logic 143 of the message broadcast application server 14 receives inputs from the information provider, creates an operation for invoking an API for message broadcast services, and invokes a message broadcast web service provided by the Parlay gateway 15.

More specifically, a message broadcast service request made by the information provider received from the user interface processing unit 141 is transferred to the message composition and management block 143a in the message broadcast processing logic 143. The message composition and management block 143a creates and transmits a broadcast message transmission request command, a broadcast message transmission request cancellation command, or a status query message according to the message broadcast service request, and receives and manages results of the transmitted command or message while storing logs associated respectively with the transmitted broadcast messages in the database 143b. The gateway-interworking block 143c is responsible for performing an actual invocation of a web service associated with the broadcast message processing and is also responsible for transmitting and receiving Simple Object Access Protocol (SOAP) messages.

In order to obtain permission to communicate with the Parlay gateway 15, the message broadcast application server 14 must first be subjected to a process for obtaining authentication and authority to access the functions of the CBS SCF 151. This process can be performed in a method recommended in the Parlay/OSA specifications and a detailed description thereof is omitted herein.

The CBS SCF 151 in the Parlay gateway 15 is responsible for processing the message broadcast API invocation (or request) from the message broadcast application server 14 described above. The CBS SCF 151 converts this request into a protocol operation format and transmits it to the CBC 161 provided in the mobile communication system 16.

More specifically, the message broadcast web service request processing block 151a in the CBS SCF 151 distributes a message broadcast API in the WSDL and processes a message broadcast web service accessed and invoked through the message broadcast API. The message conversion and management block 151b converts a web service invocation requested by the message broadcast web service request processing block 151a into a suitable message for transmission to the CBC. The message conversion and management block 151b converts a result received from the CBC 161 back to a web service message and transfers the message to the message broadcast application server 14 through the message broadcast request processing block 151a.

The request, which has been converted to a message of a lower protocol such as the SMPP through the message conversion and management block 151b, is transferred to the CBC-interworking processing block 151d. The CBC-interworking processing block 151d transmits the request to the CBC 161 in the mobile communication system 16, and receives a response to the request from the CBC 161 and transfers the response to the message conversion and management block 151b.

The CBC 161 processes the message according to a CBS service message processing procedure specified in the 3GPP or 3GPP2 specifications, so that the message is broadcast to all mobile communication terminals 17 and 18 in the service area defined by the information provider.

When the mobile communication terminals 17 and 18 receive the message, text of the message is displayed on their screens in the same manner as when a general SMS message is received.

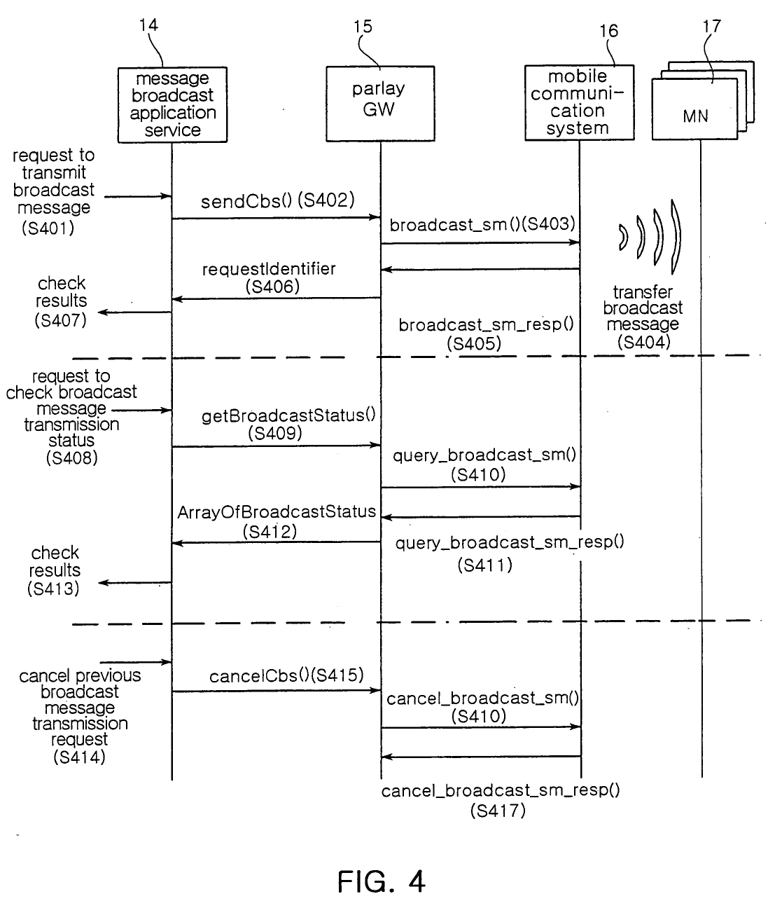

FIG. 4 is a signal flow diagram of a method for providing a message broadcast service according to the present invention.

Information exchanged between the message broadcast application server 14 and the Parlay gateway 15 is carried in a Simple Object Access Protocol (SOAP) message for use in web service transmission. An operation and parameters in the SOAP message are written (or created) according to WSDL which is a language for describing web services. An interface between the Parlay gateway 15 and the CBC 161 in the mobile communication system 16 uses a protocol (typically, SMPP v5.0) for accessing the CBC 161 from an external node.

The functions of the open API defined for message broadcast services performed by the message application server 14 are divided into three.

The first function of the open API is a function to process message broadcast requests.

When receiving a broadcast message transmission request from an information provider, the message broadcast application server 14 creates and transfers a broadcast message transmission request command sendCbs( ) to the Parlay gateway 15 (S401 and S402).

The broadcast message transmission request command sendCbs( ) includes a service area (broadcastAreaSet) in which a corresponding message is to be broadcast, a message sender name (senderName) to be displayed on the message that has been broadcast, a broadcast message (broadcastMessage) requested by the information provider, a first delivery time (deliveryTime) indicating when the message is to be initially broadcast, a broadcast repetition count (numberOfRepetition) indicating the number of times the message is repeatedly transmitted, a broadcast interval (frequencyInterval) indicating the time interval at which the message is repeatedly broadcast, and a call back number (callbackNumber) to be used as an access point connected for interaction.

Typical geographical area representation methods for defining the service area (broadcastAreaSet) include an ellipsoid arc representation method and a polygon representation method specified in Geographical Area Description (GAD) specifications (3GPP TS 23.032).

The items (senderName, deliveryTime, and callbackNumber) may not be included in the broadcast message transmission request command sendCbs( ) according to the information provider's request. When the item (deliveryTime) is not included in the broadcast message transmission request command sendCbs( ), the message is transmitted immediately after it is received. When the two items (senderName and callbackNumber) are not included in the broadcast message transmission request command sendCbs( ), the two items are not displayed on the message to be broadcast. The item (broadcastMessage) may include not only a simple short message in text format such as an SMS message but also a multimedia message such as an MMS message.

When receiving the broadcast message transmission request command SendCbs( ) configured as described above, the CBS SCF 151 in the Parlay gateway 15 converts the broadcast message transmission request command SendCbs( ) into an SMPP protocol operation broadcast_sm( ) and transfers the SMPP protocol operation broadcast_sm( ) to the mobile communication system 16 (S403). The CBC 161 in the mobile communication system 16 processes the operation broadcast_sm( ) to convert the service area to a cell ID, transfers the broadcast message of the information provider to a BTS 163 corresponding to the cell ID, and transmits the broadcast message to all mobile communication terminals 17 in the service area specified by the information provider through the BTS 163. The mobile communication system 16 then transfers a result of the broadcast message transmission to the Parlay gateway 15 using a response message broadcast_sm_resp( ) (S405).

The Parlay gateway 15 creates a transmission request identifier “requestIdentifier” for future operations, such as the checking of the transmission status of the broadcast message transmission request command SendCbs( ) or cancellation of the transmission of the broadcast message transmission request command SendCbs( ), from the response message broadcast_sm_resp( ), and transmits the created request identifier to the message broadcast application server 14 (S406).

The message broadcast application server 14 stores the transmission request identifier “requestIdentifier” received from the Parlay gateway 15 and provides a processing result of the broadcast message transmission request to the information provider (S407).

The second function of the open API is a function to check the status of transmission of a broadcast message transmission request that has been previously made.

When the message broadcast application server 14 receives a request to check the transmission status of the broadcast message from the information provider that has requested the transmission of the broadcast message as described above (S408), the message broadcast application server 14 creates a broadcast status query command getBroadcastStatus( ) using the transmission request identifier “requestIdentifier” obtained at step S407 as an argument and transmits the created command getBroadcastStatus( ) to the Parlay gateway 15 (S409).

Then, the CBS SCF 151 in the Parlay gateway 15 maps and converts the broadcast status query command getBroadcastStatus( ) into an SMPP protocol operation query_broadcast_sm( ) and queries the mobile communication system 16 about the transmission status of the specific broadcast message. The CBC 161 in the mobile communication system 16 then processes the operation query_broadcast_sm( ) to check the transmission status of the broadcast message identified by the transmission request identifier “requestIdentifier” and transmits the checked result to the Parlay gateway 15 through a response message query_broadcast_resp( ) (S410 and S411). The Parlay gateway 15 then incorporates the checked result into a parameter “ArrayOfBroadcastStatus” representing an area-by-area broadcast status to transmit it to the message broadcast application server 14 (S412).

The area-by-area broadcast status parameter “ArrayOfBroadcastStatus” is represented by pairs of service areas, in which it is requested that the message be broadcast, and transmission status values corresponding respectively to the service areas. Status values representing the broadcast status include a message transmission waiting state value “MessageWaiting” indicating that a request to transmit the broadcast message has been received but the broadcast message has not yet been transmitted, a message transmission state value “Enroute” indicating that transmission of the broadcast message from the mobile communication system 16 to the mobile communication terminal 17 is in progress or that a reattempt of the transmission is in progress, a delivered state value “Delivered” indicating that the broadcast message has been successfully transmitted to the mobile communication terminal 17, an uncertain delivery state value “deliveryUncertain” indicating that the delivery status of the message is uncertain due to an internal problem of the CBC 161 or the Parlay gateway 15, an impossible delivery state value “DeliveryImpossible” indicating that an error has occurred during transmission or that transmission cannot be reattempted anymore, an expired transmission validity state value “Expired” indicating that the validity of the broadcast message has been expired, and a deleted message state value “Deleted” indicating that the message has been deleted.

When receiving the area-by-area broadcast status parameter “ArrayOfBroadcastStatus”, the message broadcast application server 14 represents the received broadcast status parameter using a web GUI or the like to allow the user (or the information provider) to recognize the broadcast status parameter. Thus, the information provider can check the transmission status of the broadcast message requested by the information provider by accessing the message broadcast application server 14 (S413).

The third function of the open API is a function to cancel a broadcast message transmission request that has been previously made. This function is valid only during or before the processing of the previous broadcast message transmission request.

When the message broadcast application server 14 receives a request to cancel the previously requested broadcast message transmission from the information provider which has requested the broadcast message transmission as described above (S414), the message broadcast application server 14 creates a cancellation request command cancelCbs( ) using the transmission request identifier “requestIdentifier” obtained at step S406 as an argument and transmits the created cancellation request command cancelCbs( ) to the Parlay gateway 15.

When receiving the cancellation request command cancelCbs( ), the Parlay gateway 15 maps and converts the cancellation request command cancelCbs( ) into an SMPP protocol broadcast cancellation operation cancel_broadcast_sm( ). The Parlay gateway 15 transmits the SMPP protocol broadcast cancellation operation cancel_broadcast_sm( ) to the mobile communication system 16 and receives the processing result of the cancellation from the CBC 161 through a response message cancel_broadcast_sm_response( ) (S416 and S417).

The present invention described above is applied when a third party information provider uses CBS communication network capabilities of the mobile communication system.

For example, conventionally, public institutions such as the Fire Prevention Office must implement individual systems compatible with the different interfaces of mobile communication providers when they need to provide disaster warning information to people in an area where a disaster such as a typhoon, flood, forest fire, or localized heavy rain, is expected. However, according to the present invention, when a public institution needs to provide such information, the public institution simply accesses the message broadcast application server 14, which provides the service interface, to define a desired broadcast service area and compose a broadcast message. The broadcast message is then processed to be compatible with the interface of the corresponding mobile communication system 16 through the message broadcast application server 14 and the Parlay gateway 15, so that the broadcast message can be transmitted to all mobile communication terminals 17 in the desired service area.

Besides such public purposes, when a shopping mall in a specific area desires to provide coupons to consumers in the vicinity for marketing purposes, an area inside or adjacent to the shopping mall is set as a service area in the message broadcast application server 14 and coupon information is incorporated into a message for transmission. Then, a corresponding message in SMPP format is transmitted to the CBC 161 of the mobile communication system 16 through the message broadcast application server 14 and the Parlay gateway 15, so that the coupon can be transmitted to mobile communication terminals 17 in the set service area through the cell broadcast service.

As is apparent from the above description, a system and method for providing a message broadcast service using an open API according to the present invention has a number of advantages. For example, Cell Broadcast Service (CBS) capabilities, which have been accessed only by existing mobile communication providers, are opened so that third party information providers can easily access and use the CBS capabilities, thereby allowing applications in a variety of fields. Thus, information providers can transmit messages simply by accessing an application server without taking into consideration the structure of the mobile communication system.

In addition, the present invention can safely provide the same interface to entities that intend to use the message broadcast service and can also provide easy scalability even when the number of entities providing the service is increased.

Especially, the present invention can be easily utilized when providing information based on specific areas such as disaster areas, department stores, hypermarkets, airports, and schools or utilized when providing advertisement information for commercial purposes.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method for providing a message broadcast service using an open Application Program Interface (API) wherein a broadcast message is transmitted to a plurality of mobile communication terminals using Cell Broadcast Service (CBS) capabilities of a mobile communication system through the open API, the method comprising the steps of:
providing a user interface for composing a broadcast message and defining a service area to a third party information provider;
receiving a broadcast message transmission request from the third party information provider through the user interface;
creating a broadcast message transmission request command using the broadcast message composed and the service area defined through the user interface upon receiving the broadcast message transmission request from the third party information provider; and
converting the broadcast message transmission request command into a format of the mobile communication system and transferring the converted broadcast message transmission request command to the mobile communication system through the open API.

2. The method according to claim 1, wherein the broadcast message transmission request command includes a service area where a corresponding message is to be broadcast, a broadcast message requested by the information provider, a broadcast repetition count indicating the number of times the message is repeatedly transmitted, and a broadcast interval indicating a time interval at which the message is repeatedly broadcast.

3. The method according to claim 2, wherein the broadcast message transmission request command further selectively includes a message sender name to be displayed on the message that has been broadcast, a first delivery time indicating when the message is to be initially broadcast, and a call back number to be used as an access point connected for interaction.

4. The method according to claim 3, wherein, when the first delivery time is not included in the broadcast message transmission request command, the broadcast message is immediately transmitted from the mobile communication system.

5. The method according to claim 1, further comprising the steps of:
receiving a broadcast message transmission request identifier received from the mobile communication system through the open API; and
storing the received broadcast message transmission request identifier.

6. The method according to claim 5, further comprising the steps of:
receiving a request to check a transmission status of a broadcast message transmission request, previously made, from the third party information provider through the user interface;
creating a broadcast status query command using an identifier of the broadcast message transmission request as an argument;
converting the created broadcast status query command into a protocol format of the mobile communication system and transferring the converted broadcast status query command to the mobile communication system through the open API;
receiving a broadcast status check result of the mobile communication system as a response message to the broadcast status query command; and
providing the received broadcast status check result to the third party information provider through the user interface.

7. The method according to claim 6, wherein the broadcast status check result is represented by pairs of service areas, in which it is requested that the message be broadcast, and transmission status values corresponding respectively to the service areas.

8. The method according to claim 6, wherein the broadcast state check result includes one of a message transmission waiting state value indicating that a request to transmit the broadcast message has been received but the broadcast message has not yet been transmitted, a message transmission state value indicating that transmission of the broadcast message from the mobile communication system is in progress or that a reattempt of the transmission is in progress, a delivered state value indicating that the broadcast message has been successfully transmitted from the mobile communication system, an uncertain delivery state value indicating that a processing status of the broadcast message is uncertain, an impossible delivery state value indicating that an error has occurred during transmission or that transmission cannot be reattempted anymore, an expired transmission validity state value indicating that validity of the broadcast message has been expired, and a deleted message state value indicating that the broadcast message has been deleted.

9. The method according to claim 5, further comprising the steps of:
receiving a request to cancel a broadcast message transmission request, previously made, from the third party information provider through the user interface;
creating a cancellation request command using an identifier of the broadcast message transmission request as an argument; and
converting the created cancellation request command into a format of the mobile communication system and transferring the converted cancellation request command to the mobile communication system through the open API.

10. The method according to any one of claims 1 to 9, wherein commands and responses transferred between a message broadcast application server and the open API are Simple Object Access Protocol (SOAP) messages.

11. The method according to any one of claims 1 to 9, wherein commands and responses transferred to the mobile communication system through the open API comply with a Short Message Peer-to-Peer (SMPP) protocol.

12. A message broadcast service system for providing a message broadcast service using an open Application Program Interface (API), the system allowing a third party information provider to transmit a broadcast message to a mobile communication terminal present in a specific service area through a Cell Broadcast Center (CBC) in a mobile communication system, the message broadcast service system comprising:
a message broadcast application server for providing a user interface so that the third party information provider can compose a broadcast message and define a service area where the broadcast service is to be transmitted and for invoking an open API for message broadcasting based on information of the service area and the broadcast message of the third party information provider received through the user interface; and
a Parlay gateway for converting a message broadcast service-related request of the message broadcast application server so as to comply with a protocol of the CBC of the mobile communication system and transferring the converted request to the CBC through protocol interworking with lower network resources of the mobile communication system, and inverse-converting and transferring a message received from the CBC to the message broadcast application server.

13. The message broadcast service system according to claim 12, wherein the message broadcast application server comprises:
a user interface processing unit for providing a user interface that supports an information provider to define a service area and compose a broadcast message and for receiving a message broadcast service-related request from the information provider or providing message broadcast service-related information to the information provider through the user interface;
a database for storing map data required to define the service area in the user interface processing unit; and
a message broadcast processing logic for creating a command for processing the broadcast message according to a request of the information provider received through the user interface processing unit, invoking an open API, and receiving a response to the command.

14. The message broadcast service system according to claim 13, wherein the message broadcast processing logic comprises:
a message composition and management block for creating a broadcast message processing command in a format set according to a request of the information provider received through the user interface processing unit and managing respective log information of broadcast messages;
a storage unit for storing the log information of the broadcast messages managed by the message composition and management block; and
a gateway-interworking block for invoking the open API, transmitting a broadcast message processing command and query created by the message composition and management block to the mobile communication system, receiving a response to the command and query, and transferring the received response to the message composition and management block.

15. The message broadcast service system according to claim 12, wherein the Parlay gateway comprises a CBS Service Capability Feature (SCF) for mapping and converting a request of the message broadcast application server according to invocation of a CBS API and transferring the converted request to the CBC of the mobile communication system through protocol interworking with lower network resources of the mobile communication system, and inverse-converting and providing a response to the request to the message broadcast application server.

16. The message broadcast service system according to claim 15, wherein the CBS SCF comprises:
a message broadcast web service request processing block for implementing and distributing an open API for broadcast message services in Web Services Description Language (WSDL) and processing a request for a message broadcast service accessed and invoked through the open API;
a message conversion and management block for converting a web service request made by the message broadcast web service request processing block so as to comply with a protocol of the mobile communication system, inverse-converting a processing result of the web service request received from the mobile communication system, converting an ID of the API invocation into a lower protocol session ID, and managing the lower protocol session ID;
a session management DB for storing session information processed by the message conversion and management block; and
a CBC-interworking processing block for transmitting a request, which has been converted to a lower protocol message by the message conversion and management block, to the CBC of the mobile communication system, receiving a response to the request from the CBC, and transferring the received response to the message conversion and management block.

17. The message broadcast service system according to claim 12, wherein the service area is represented using an ellipsoid arc representation method or a polygon representation method specified in Geographical Area Description (GAD) specifications.

18. The message broadcast service system according to claim 12, wherein information exchanged between the message broadcast application server and the Parlay gateway is carried in a Simple Object Access Protocol (SOAP) message for use in web service transmission.

19. The message broadcast service system according to claim 12, wherein the Parlay gateway accesses the CBC of the mobile communication system using a Short Message Peer-to-Peer (SMPP) protocol.

20. A message broadcast application server for transmitting a broadcast message to a mobile communication terminal present in a specific service area using Cell Broadcast Service (CBS) capabilities of a mobile communication system through an open API, the server comprising:
a user interface processing unit for providing a user interface that supports an information provider to define a service area and compose a broadcast message and for receiving a message broadcast service-related request from the information provider or providing message broadcast service-related information to the information provider through the user interface;
a database in which the user interface processing unit stores map data representing an area where a message broadcast service is to be provided; and
a message broadcast processing logic for creating a command for processing the broadcast message according to a request of the information provider received through the user interface processing unit, invoking an open API, and receiving a response to the command.

21. The server according to claim 20, wherein the message broadcast processing logic comprises:
a message composition and management block for creating a broadcast message processing command in a format set according to a request of the information provider received through the user interface processing unit and managing respective log information of broadcast messages;
a storage unit for storing the log information of the broadcast messages managed by the message composition and management block; and
a gateway-interworking block for invoking the open API, transmitting a broadcast message processing command and query created by the message composition and management block to the mobile communication system, receiving a response to the command and query, and transferring the received response to the message composition and management block.

22. A Parlay gateway for providing an open API of a Cell Broadcast Center (CBC) of a mobile communication system for providing a message broadcast service, the Parlay gateway comprising a CBS Service Capability Feature (SCF) comprising:
a message broadcast web service request processing block for implementing and distributing an open API for broadcast message services in Web Services Description Language (WSDL) and processing a request for a message broadcast service accessed and invoked through the open API;
a message conversion and management block for converting a web service request made by the message broadcast web service request processing block so as to comply with a protocol of the mobile communication system, inverse-converting a processing result of the web service request received from the mobile communication system, converting an ID of the API invocation into a lower protocol session ID, and managing the lower protocol session ID;
a session management DB for storing session information processed by the message conversion and management block; and
a CBC-interworking processing block for transmitting a request, which has been converted to a lower protocol message by the message conversion and management block, to the CBC of the mobile communication system, receiving a response to the request from the CBC, and transferring the received response to the message conversion and management block.
